(19) United States
(12) Patent Application Publication
(10) Pub. No.: US 2022/0253817 A1
(43) Pub. Date: Aug. 11, 2022

(54) AUTOMATED AI SYSTEMS AND METHODS FOR PERSONALIZED SAVINGS OR DEBT PAYDOWN

(71) Applicants: David Sosna, Tel Aviv (IL); David Govrin, Tel Aviv (IL); Jody Bhagat, Los Altos, CA (US)

(72) Inventors: David Sosna, Tel Aviv (IL); David Govrin, Tel Aviv (IL); Jody Bhagat, Los Altos, CA (US)

(21) Appl. No.: 17/534,380

(22) Filed: Nov. 23, 2021

Related U.S. Application Data
(60) Provisional application No. 63/117,050, filed on Nov. 23, 2020.

(51) Int. Cl. G06Q 20/10; G06Q 20/40

(52) U.S. Cl. CPC G06Q 20/108; G06Q 10/04; G06Q 20/405

(57) ABSTRACT

In one aspect, a computerized method for automated personalized savings comprising: enabling a consumer to identify a source checking account for income deposits and an amount to save; linking the source checking account as a source of funds; determining an amount the customer is able save based on a balance forecast model predictions model; determining the amount the customer is able to save meets a customers request; and delivering an instructions to a bank to transfer a designated amount to a destination savings account.

### CLAIM OF PRIORITY

This application claims priority to U.S. Provisional Patent Application No. 63/117,050, filed on Nov. 23, 2020 and titled AUTOMATED AI SYSTEMS AND METHODS FOR PERSONALIZED SAVINGS OR DEBT PAYDOWN. This provisional application is hereby incorporate by reference in its entirety.

### BACKGROUND

Financial institutions are seeking ways to improve their customers' financial well being. A primary financial institution typically has access to customers' transaction data that identifies specific cash flow patterns, including inflows and outflows of deposits and expenses. By understanding the cash flow patterns and needs for individual customers, financial institutions can help them better manage their day-to-day banking though autonomous finance programs with customer consent. These autonomous finance programs can utilize machine learning techniques to create a deep understanding of customers' cash flow needs to determine how much capacity can be set aside for savings and/or debt paydown.

### SUMMARY OF THE INVENTION

In one aspect, a computerized method for automated personalized savings comprising: enabling a consumer to identify a source checking account for income deposits and an amount to save; linking the source checking account as a source of funds; determining an amount the customer is able save based on a balance forecast model predictions model; determining the amount the customer is able to save meets a customers request; and delivering an instructions to a bank to transfer a designated amount to a destination savings account.

In another aspect, a computerized method for an automatic accelerated debt paydown comprising: enabling a user to opt into accelerated debt paydown process by: identifying one or more current loans of the user; linking a source account in a source bank as a fund source; analyzing a user transaction data; identifying an amount the user can set aside towards debt paydown; and delivering an electronic instruction to the source bank to transfer a designated amount to paydown a loan principal of the one or more current loans.

In yet another aspect, a computerized method of a multi-intent optimization process that provide an automated and an intelligent movement of money to solve for both saving money and paying down debt comprising: recognizing any available funds in a primary checking account; linking to a source account for funds; enabling a customer to identify a destination account and a target loan to pay down; executing a batch process that analyzes customer transaction data; identifying an amount of the funds that a consumer is able to set aside with an allocation model; implementing an allocation model that: determines a first portion of the amount that is transferred to a saving account; determines a second portion of the amount versus paying down debt; delivering a set of electronic instructions to a relevant bank server of the primary checking account to transfer the first portion of the amount to a savings account and the second portion of the amount to a targeted loan principal.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for personalized automated AI savings and/or debt paydown program, according to some embodiments.

FIG. 2 illustrates an example personalized auto savings process, according to some embodiments.

FIG. 3 illustrates an example screen shot illustrating personalized auto savings product, according to some embodiments.

FIG. 4 illustrates an example accelerated debt paydown process, according to some embodiments.

FIG. 5 illustrates an example screenshot illustrating an accelerated debt paydown products, according to some embodiments.

FIG. 6 illustrates an example multi-intent optimization process, according to some embodiments.

FIG. 7 illustrates an example personalized automated AI savings and/or debt paydown model, according to some embodiments.

FIG. 8 illustrates an example transaction enrichment layer, according to some embodiments.

FIG. 9 illustrates an example activity analysis layer, according to some embodiments.

FIG. 10 illustrates an example action recommendation layer, according to some embodiments.

FIG. 11 illustrates an example implementation customer interaction layer, according to some embodiments.

FIG. 12 depicts an exemplary computing system that can be configured to perform any one of the processes provided herein.

The Figures described above are a representative set, and are not exhaustive with respect to embodying the invention.

### DESCRIPTION

Disclosed are a system, method, and article of manufacture of an automated artificially intelligent (AI) systems and methods for personalized savings or debt paydown. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Application programming interface (API) can specify how software components of various systems interact with each other.

Deep learning is a family of machine learning methods based on learning data representations. Learning can be supervised, semi-supervised or unsupervised.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Exemplary Methods and Systems

Personalized automated AI savings and/or debt paydown programs intelligently grow savings and/or accelerate debt paydown on behalf of a consumer. Personalized automated AI savings and/or debt paydown programs can use machine learning-based models that analyze historical financial transaction data, including recurring, scheduled, and patterned income and expenses, to determine how much money to transfer to savings or debt paydown, and initiate the transaction on a consumer's behalf.

Personalized automated AI savings and/or debt paydown programs interact with current bank technologies, and use the bank platforms to perform various tasks. These can include, inter alia: provide customer awareness of the solution and enable enrollment into the solution; provide customers with terms and conditions and capture approval signature; (optionally) link an external source funding account; move funds from a source funding bank account to a specified debt (e.g. mortgage, student loan, or other loan account via a bank or a third party); apply funds to pay down loan principal; etc.

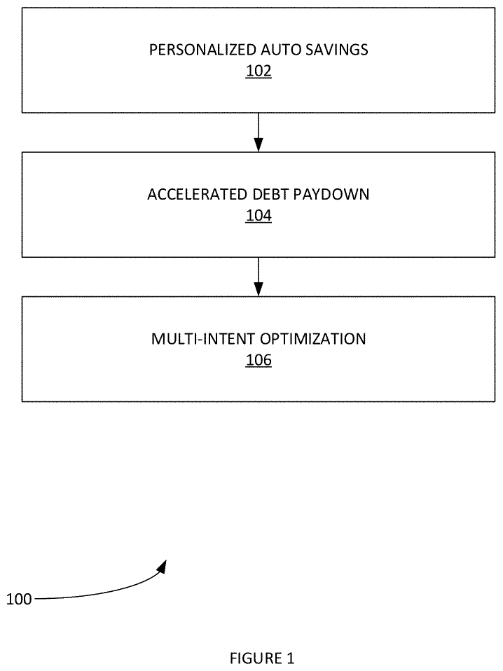

FIG. 1 illustrates an example process 100 for personalized automated AI savings and/or debt paydown program, according to some embodiments. In step 102, process 100 can implement personalized auto savings. Process 100 can enable intelligent savings automation to help customers save in an automated way. For example, a bank can offer a simple automated transfer solution that allows customers to set an amount to be transferred to savings every month.

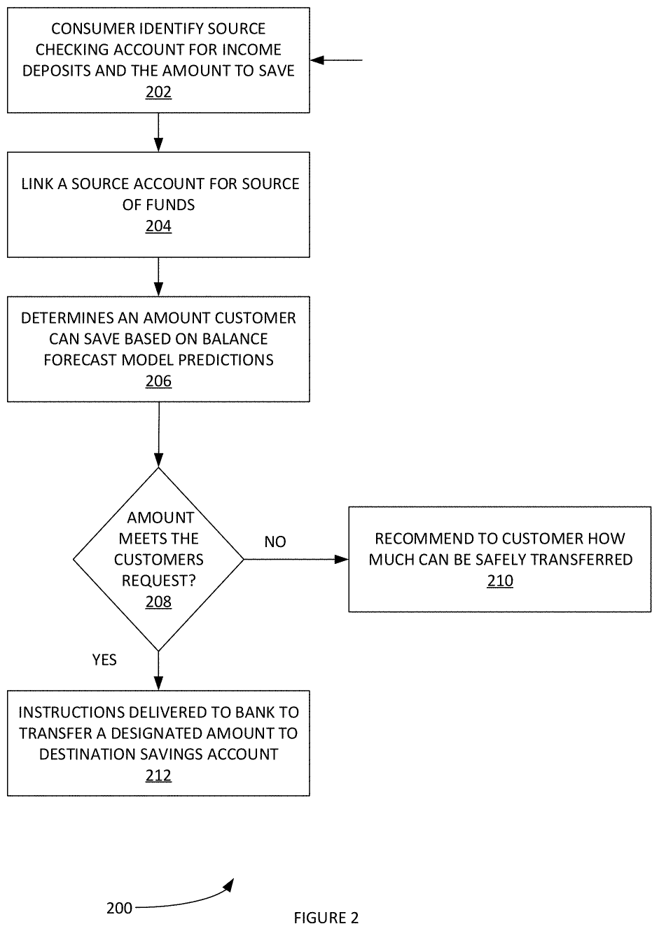

FIG. 2 illustrates an example personalized auto savings process 200, according to some embodiments. In one example, the personalized auto savings process 200 can be used to intelligently set aside savings from paycheck based on your personalized cash flow needs. Personalized auto savings process 200 can use specified ML and AI algorithms to identify specified funds available in a primary checking account based on forecasted expenses.

More specifically, in step 202, consumers can opt into (e.g. a “Pay Yourself First” program, etc.). The consumer can identify the source checking account for income deposits and the amount they would like to save. In step 204, the consumers can link a source account for source of funds.

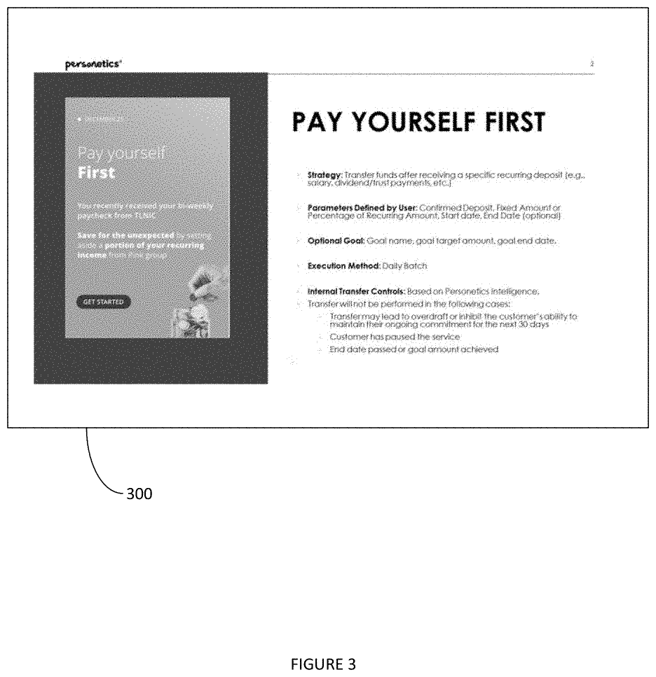

Process 200 can run balance-forecasting model predictions. An example discussion of a balance-forecasting model is provided infra. Accordingly, in step 206, at the point of paycheck deposit (e.g. weekly, bi-weekly, monthly, etc.), process 200 determines an amount a customer can save in light of balance forecast model predictions. In step 208, process 200 can determine if the amount meets the customers request. If, ‘no’, then process 200 can recommend to the customer how much can be safely transferred in step 210. If ‘yes’, then process 200 can proceed to step 212. In step 212, instructions are delivered to the bank to transfer a designated amount to a destination savings account (e.g. savings, money market, or investment). In step 214, process 200 tracks how much money has been sent to the destination savings by the customer in the program. Optionally, process 200 can provide various milestones. FIG. 3 illustrates an example screen shot 300 illustrating a personalized auto savings product, according to some embodiments.

Returning to process 100, in step 104, process 10 0 can implement an ML-enables an accelerated debt paydown algorithm. The accelerated debt paydown algorithm (e.g. a digit debt manager’, etc.) uses an algorithm for customers to move money from checking to pay an outstanding debt. Process 100 can assess a person's free cash flow. The accelerated debt paydown algorithm can be delivered through banks as an offering to their customers. The accelerated debt paydown algorithm can involve use case applications using a similar technology that is based on an intelligent understanding of customer cash flows to improve either saving or debt paydown. A first application of the accelerated debt paydown algorithm can intelligently identify an amount of a person's paycheck that can be safely set aside into a savings or investment instrument. The first application of the accelerated debt paydown algorithm can be based on an understanding of a person's incomes and expenses historically with a higher weighting on recent activity. In some example embodiments, the second application of the accelerated debt paydown algorithm can use the same technology and algorithms of first application of the accelerated debt paydown algorithm but tuned more conservatively. The second application of the accelerated debt paydown algorithm can be an accelerated debt paydown application. This can be high-interest debt (e.g. credit card, personal loan, student loan, mortgages, etc.). The accelerated debt paydown algorithm can result in lower overall interest expense and accelerated payoff. The accelerated debt paydown algorithm can use machine learning algorithms to review and analyze a customer's source funding account to identify how much money can be safely removed based on an understanding of customer transaction activity, cash flows, and upcoming needs.

In one example the accelerated debt paydown algorithm can apply a balance-forecasting model. The balance-forecasting model can provide a prediction of an amount of funds needed to cover essential and non-essential expenses over a period of time (e.g. until the next expected deposit, etc.). When process 100 determines that money can be moved, a money movement instruction is delivered to the specified bank to transfer the specified amount to a savings account (e.g. in step 102) or apply it to a specified loan (e.g. in step 104). The balance forecasting algorithm is dynamic and adaptable, and provides heavier weighting to recent activity. In an example case of step 102, the evaluation process and money movement can occur at a specified trigger, such as based on a paycheck cycle (e.g. bi-weekly, monthly, etc.). The funds can be directed to a savings or an investment account. The balance-forecasting model can be directed to meet a goal (e.g. vacation, purchase an automobile, etc.) that has been established or simply to improve savings behavior without a goal. In the example of an accelerated debt paydown process, the balance-forecasting model process can occur multiple times a week, recognizing how much money can be safely applied to the loan at any given point in time. Balance-forecasting model solutions can be configured by a financial entity (e.g. bank) to set thresholds for the number of times money movement occurs, amounts, and minimum balances.

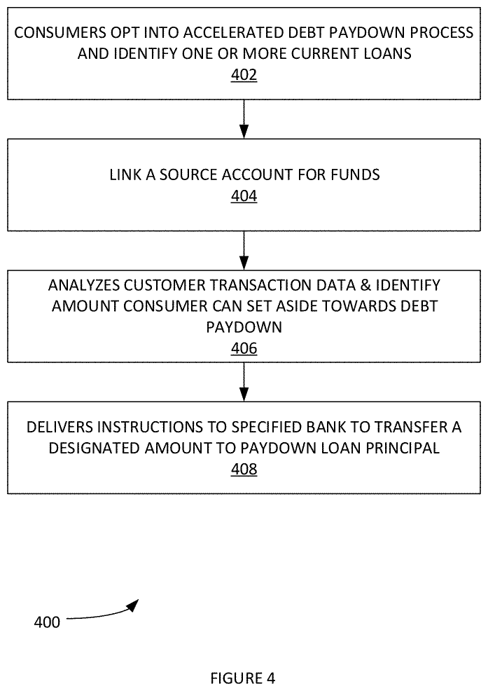

FIG. 4 illustrates an example accelerated debt paydown process 400, according to some embodiments. Process 400 can recognize available funds in a primary checking account to make multiple incremental payments (e.g. principal) to loan balance every month (and/or other specified period). In step 402, consumers opt into accelerated debt paydown process 400 and identify one or more current loans. In step 404, process 400 can link a source account for funds. In step 406, on a periodic basis, process 400 executes a batch process that analyzes customer transaction data and identifies an amount a consumer can set aside towards debt paydown. This can be based on the consumer's planned cash flows and expenses. In step 408, process 400 delivers instructions to the specified bank to transfer a designated amount to paydown the loan (e.g. mortgage, student loan, credit card debt, line, etc.) principal. Accordingly, the loan provider reduces principal by transferred amount. Process 400 can track the amount of funds that have has been saved by the customer based on accelerated paydown

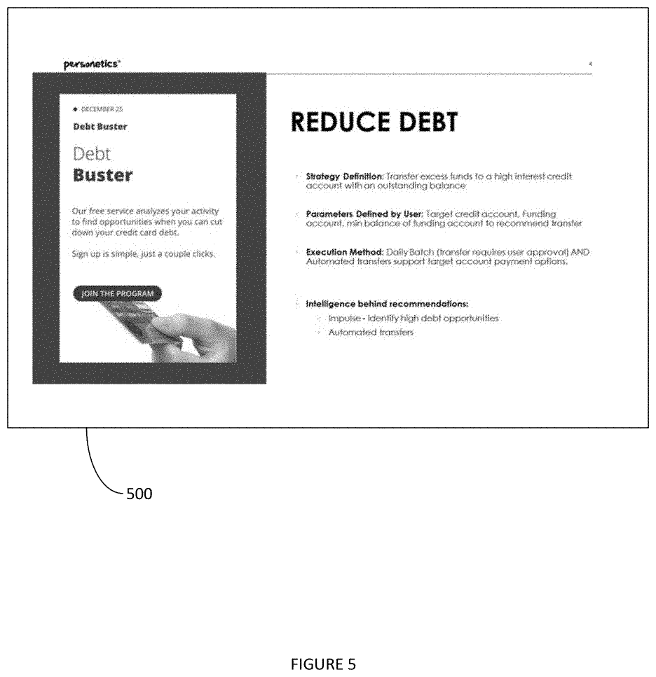

FIG. 5 illustrates an example screenshot illustrating an accelerated debt paydown products, according to some embodiments.

Returning to process 100, in step 106, process 100 can implement multi-intent optimization. For example, a bank can use multi-intent optimization to solve for multiple intents (e.g. savings and debt paydown) concurrently. Process 100 can enable customers to optimize for multiple intents, as a customer can have both automated savings and debt paydown goals. It is noted that process 100 (as well as subprocesses provided herein) can be implemented in a personalized automated AI savings and/or debt paydown application. The personalized automated AI savings and/or debt paydown application can be implemented in a mobile device, web page, etc.

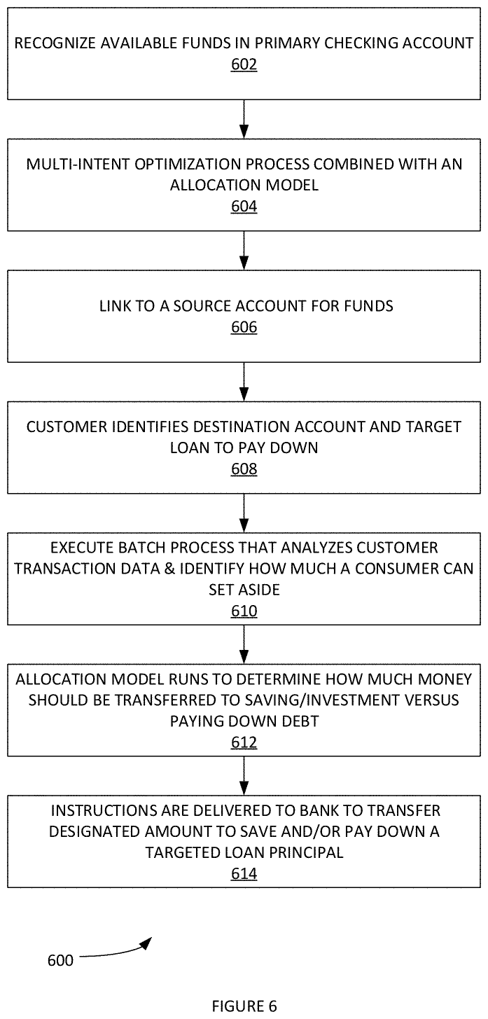

FIG. 6 illustrates an example multi-intent optimization process 600, according to some embodiments. Multi-intent optimization process 600 can provide automated and intelligent movement of money to solve for both saving money and paying down debt. Multi-intent optimization process 600 can recognize available funds in a primary checking account in step 602. The multi-intent optimization process 600 can be combined with an allocation model that determines how much to allocate to savings versus paying down debt in step 604. Multi-intent optimization process 600 can link to a source account for funds in step 606. In step 608, the customer identifies two intents: a) save; b) pay down debt. In step 608, the customer identifies the destination account (e.g. a savings and/or investment account, etc.) and the target loan to pay down. In step 610, on a periodic basis (e.g. a daily basis, a regular basis, a weekly basis, etc.), multi-intent optimization process 600 executes a batch process that analyzes customer transaction data and identifies how much a consumer can set aside towards savings or debt paydown based on their planned cash flows and expenses. In step 612, an allocation model runs to determine how much money should be transferred to saving/investment versus paying down debt. In step 614, instructions are delivered to the bank to transfer a designated amount to either save and/or pay down a targeted loan principal (e.g. mortgage, student loan, credit card debt, line, etc.). The amount is credited to the saving or investment account. The loan provider reduces principal by transferred amount. Multi-intent optimization process 600 can tracks the amount of funds that have been saved by the customer based on savings and accelerated paydown.

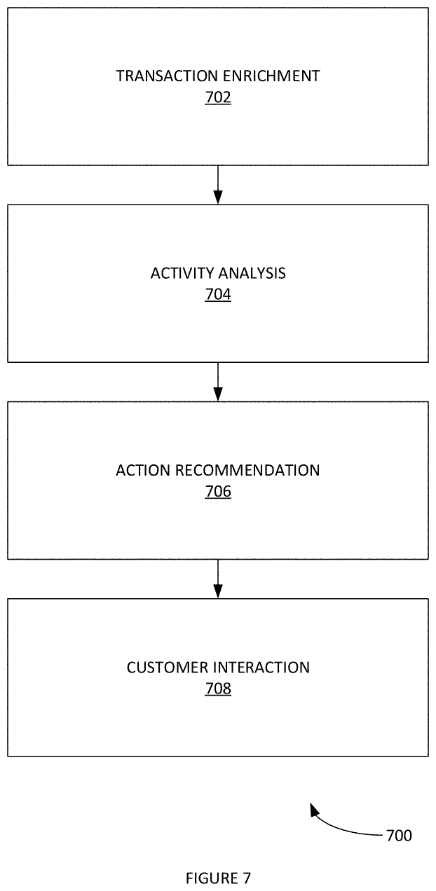

FIG. 7 illustrates an example personalized automated AI savings and/or debt paydown model 700, according to some embodiments. It is noted that output of a model in one layer provide be valuable input to models in subsequent layers. In layer 702, personalized automated AI savings and/or debt paydown model 700 can implement transaction enrichment. In layer 704, personalized automated AI savings and/or debt paydown model 700 can implement activity analysis. In layer 706, personalized automated AI savings and/or debt paydown model 700 can implement an action recommendation. In layer 708, personalized automated AI savings and/or debt paydown model 700 can implement customer interaction(s).

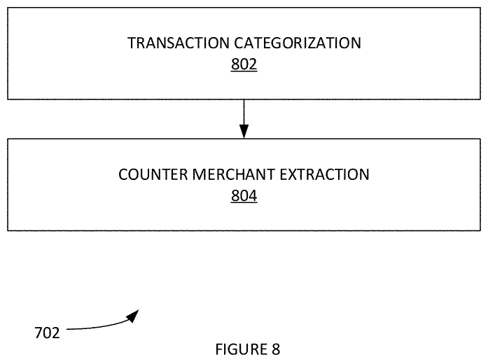

FIG. 8 illustrates an example transaction enrichment layer 702, according to some embodiments. Enrichment layer 702 can include transaction categorization 802. Transaction categorization 802 can utilize a machine learning model to enrich data on merchants and counterparties including name category, and other attributes. Additionally, counter merchant extraction 804 can be implemented.

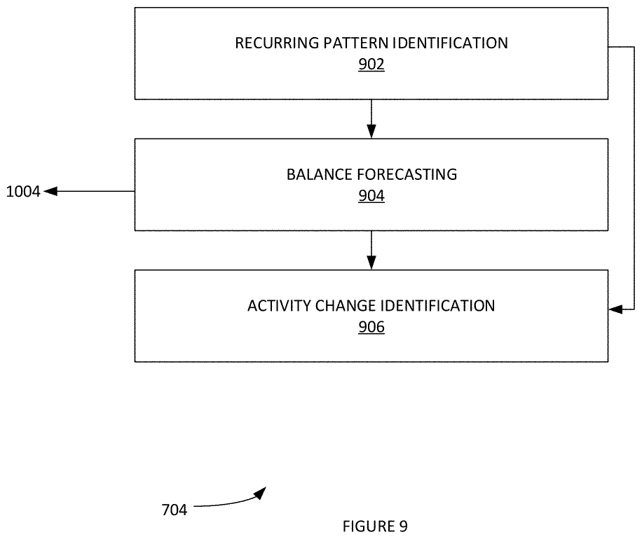

FIG. 9 illustrates an example activity analysis layer 704, according to some embodiments. Activity analysis layer 704 can include recurring pattern identification 902. Recurring pattern identification 902 can utilize a time series model that analyzes the historical activity in an account and recognizes which transactions have a recurring pattern. Additionally, balance forecasting 904. Balance forecasting 904 can include the methods provided with respect to the balance-forecasting model discussed supra. Balance forecasting 904 can use a model that analyzes the historical activity in an account to estimate upcoming activity and its impact on the account balance. The output of balance forecasting 904 can be provided to step 1004. Activity change identification 906 can then use a statistical inference process that compares the current activity on an account to the history and recognizes meaningful changes.

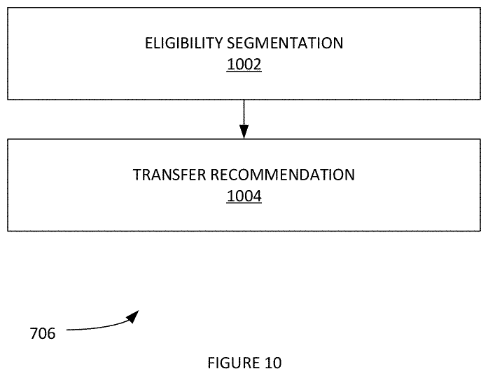

FIG. 10 illustrates an example action recommendation layer 706, according to some embodiments. Action recommendation layer 706 can include eligibility segmentation 1002. Eligibility segmentation 1002 can use a segmentation model to identify relevant accounts and users based on their cash-flow behaviors and their upside potential. Action recommendation layer 706 can include transfer recommendation 1004. Transfer recommendation 1004 can be applied on eligible users and searches for opportunities to transfer a small amount of money from their checking account to savings account without risking the balance condition.

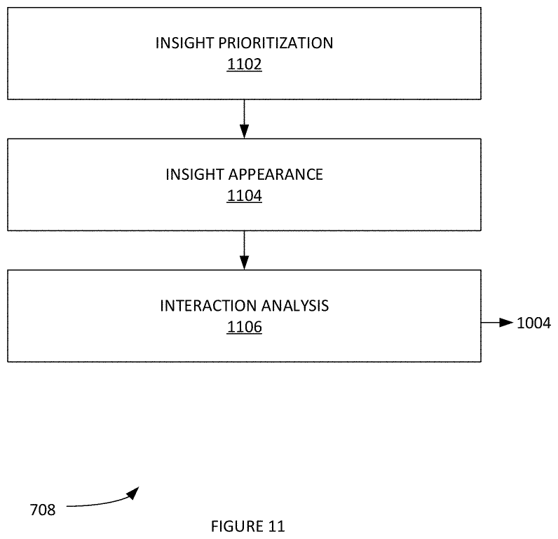

FIG. 11 illustrates an example implementation customer interaction layer 708, according to some embodiments. Customer interaction layer 708 can include insight prioritization 1102. Insight prioritization 1102 can include a set of recommendation algorithms that use past user interactions to adjust the score of each insight according to the context and the user's preferences. Insight Appearance 1104 can include a set of algorithms that define how long the insight should be presented and when it should trigger next. Finally, insight analysis 1106 can be applied. The output of insight analysis 1106 can be communicated to 1004 as well.

Additional steps, modifications, and variations of a personalized automated AI savings and/or debt paydown model can be implemented. In one example, personalized automated AI savings and/or debt paydown model 700 can include two processes, both of which rely on platform models. This can include an eligibility segmentation process. The eligibility segmentation process can use a dedicated model to distinguish where customers reside in the eligibility segments. Another can be a transfer recommendation process. This can utilize, in addition to the set of rules and thresholds, a balance model. The personalized automated AI savings and/or debt paydown model 700 can determine which customers can benefit from the auto-savings program using a proprietary eligibility process. The eligibility process can be applied to all bank customers for whom the personalized automated AI savings and/or debt paydown model 700 receives data. Each of the customer's accounts is assigned to a segment.

Based on the assigned segments, the customer is then also assigned to a segment and his accounts are ranked by relevancy to the program. The segments can be as follows: Segment 5—Does not meet base condition (not eligible); Segment 4—Insufficient data to determine eligibility (not eligible); Segment 3—Customer's assets and activity is too large to appreciate program (not eligible); Segment 2—Customer's capacity to save is too small to benefit from program (not eligible); Segment 1—Customer can benefit from service (eligible). The eligibility process begins with a preliminary filtering process to remove customers who do not meet the bank's base conditions (e.g. see segment 5). This segment is defined by a set of threshold-based rules. The next phase focuses on recognizing accounts/users who do not have sufficient data for the personalized automated AI savings and/or debt paydown model 700 to analyze them appropriately (e.g. see segment 4). This segment is also defined by the set of threshold-based rules. The next phase focuses on recognizing wealthy users who the personalized automated AI savings and/or debt paydown model 700 assumes will not appreciate the Act service (e.g. see segment 3). This segment is also defined by the set of threshold-based rules. The eligibility model is applied to the remaining population in order to segment the customers into two groups.

Customers in segment 1 are considered eligible for the Auto-Savings program and their activity is analyzed in the balance model. Customers in segment 2 are not expected to benefit significantly from the service (e.g. because of limited free cash) and therefore are not recommended for the auto-savings program.

The transfer recommendation process is now discussed. The transfer recommendation process is applied during a pre-defined recurring period. Users are reviewed. Users that are enrolled in an auto-savings service are analyzed. If there is an opportunity to transfer a small amount of money from their checking account to savings account without risking the balance condition, personalized automated AI savings and/or debt paydown model 700 can instruct the bank to do so. The transfer recommendation algorithm relies on data elements from user profiles and real-time data sources.

Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

Additionally, machine learning can refer to algorithms and methods, known also as artificial intelligence (AI), that provide computers with the ability to learn without being explicitly programmed. Machine learning can be used to generate and manage one or more Personetics models. Personetics models are trained on a massive amount of banking data which represents diverse users' behaviors and activities from many financial organizations and geographies. To ensure the highest quality results, Personetics models can use feature pre-processing to enhance input values. Pre-processing utilizes advanced methods of data modeling and manipulation. The data is evaluated for various applications (e.g. account balance level, eligibility for saving, recurring spend or deposit activities, etc.) by Personetics business experts. The Personetics models are trained based on Personetics data assets and knowledge, learning the relationships between data features and the expected outcomes. In order to identify eligible users and to recognize situations in which user balance is sufficient for saving, state-of-the-art models are utilized (e.g. novel deep learning neural networks as well as gradient boosting and logistic regression are used, etc.). Personetics models yield highly accurate predictions that support various business decisions for new (e.g. unseen) users' data in real time.

Additional Systems and Architecture

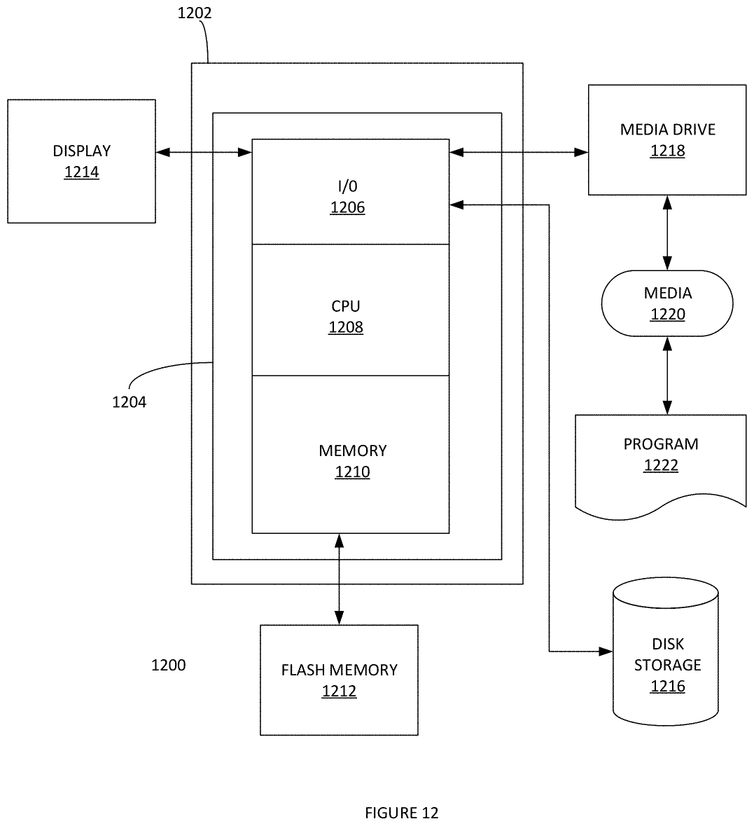

FIG. 12 depicts an exemplary computing system 1200 that can be configured to perform any one of the processes provided herein. In this context, computing system 1200 may include, for example, a processor, memory, storage, and I/O devices (e.g., monitor, keyboard, disk drive, Internet connection, etc.). However, computing system 1200 may include circuitry or other specialized hardware for carrying out some or all aspects of the processes. In some operational settings, computing system 1200 may be configured as a system that includes one or more units, each of which is configured to carry out some aspects of the processes either in software, hardware, or some combination thereof.

FIG. 12 depicts computing system 1200 with a number of components that may be used to perform any of the processes described herein. The main system 1202 includes a motherboard 1204 having an I/O section 1206, one or more central processing units (CPU) 1208, and a memory section 1210, which may have a flash memory card 1212 related to it. The I/O section 1206 can be connected to a display 1214, a keyboard and/or other user input (not shown), a disk storage unit 1216, and a media drive unit 1218. The media drive unit 1218 can read/write a computer-readable medium 1220, which can contain programs 1222 and/or data. Computing system 1200 can include a web browser. Moreover, it is noted that computing system 1200 can be configured to include additional systems in order to fulfill various functionalities. Computing system 1200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Example Use Case

Users can be invited to join a program and elect a source funding account. A ML model can then be implemented to understand the user's historical cash flows, predict/optimize future cash flows, and direct specified funds to a target account (e.g. savings account or paying down a specified debt). A rules-based tool set can be provided that enables the financial institutions (e.g. a bank, etc.) to adjust relevant thresholds and policies. In this way, there can be parameters that are set by the financial institution that dictate the target accounts and how much is sent to these accounts. For example, the frequency, amount, other thresholds, policies, etc. can be used to adjust the target entities and the amount of funds in a payment. The financial institution can also specify conditions that the funds can and cannot be moved. ML algorithms can be checked against the financial institution settings/thresholds.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for automated personalized savings comprising:
enabling a consumer to identify a source checking account for income deposits and an amount to save;
linking the source checking account as a source of funds;
determining an amount the customer is able save based on a balance forecast model predictions model;
determining the amount the customer is able to save meets a customers request; and
delivering an instructions to a bank to transfer a designated amount to a destination savings account.

2. The computerized method of claim 1, further comprising:
recommending to the customer how much can be safely transferred to the destination savings account.

3. The computerized method of claim 2, further comprising:
using a specified machine learning algorithm to identify the amount to save in the primary checking account based on one or ore forecasted expenses.

4. The computerized method of claim 3, further comprising:
using a specified machine learning algorithm to generate and maintain a balance-forecasting model; and
using the balance-forecasting model to identify the amount to save in the primary checking account based on one or ore forecasted expenses.

5. A computerized method for an automatic accelerated debt paydown comprising:
enabling a user to opt into accelerated debt paydown process by:
identifying one or more current loans of the user;
linking a source account in a source bank as a fund source;
analyzing a user transaction data;
identifying an amount the user can set aside towards debt paydown; and
delivering an electronic instruction to the source bank to transfer a designated amount to paydown a loan principal of the one or more current loans.

6. The computerized method of claim 5, wherein the one or more loans comprises a mortgage loan, a student loan, or a credit card debt.

7. The computerized method of claim 6, wherein the source account comprises a source checking account of the user.

8. A computerized method of a multi-intent optimization process that provide an automated and an intelligent movement of money to solve for both saving money and paying down debt comprising:
recognizing any available funds in a primary checking account;
linking to a source account for funds;
enabling a customer to identify a destination account and a target loan to pay down;
executing a batch process that analyzes customer transaction data;
identifying an amount of the funds that a consumer is able to set aside with an allocation model;
implementing an allocation model that:
determines a first portion of the amount that is transferred to a saving account;
determines a second portion of the amount versus paying down debt;
delivering a set of electronic instructions to a relevant bank server of the primary checking account to transfer the first portion of the amount to a savings account and the second portion of the amount to a targeted loan principal.
